(19) United States
(12) Patent Application Publication
(10) Pub. No.: US 2026/0065033 A1
(43) Pub. Date: Mar. 5, 2026

(54) GENERATING OUTPUT SEQUENCES USING A TOKEN PROCESSING NEURAL NETWORK AND EXTERNAL TOOLS

(71) Applicant: DeepMind Technologies Limited, London (GB)

(72) Inventors: Matthew Sharifi, Kilchberg (CH); Florian Nils Hartmann, Zürich (CH)

(21) Appl. No.: 18/824,081

(22) Filed: Sep. 4, 2024

(51) Int. Cl. G06N 3/0475; G06F 9/54; G06N 3/092

(52) U.S. Cl. CPC G06N 3/0475; G06F 9/541; G06N 3/092

(57) ABSTRACT

Methods, systems, and apparatus, including computer programs encoded on computer storage media, for generating output sequences using a token processing neural network and one or more external tools. The output sequences are then presented for display.

### BACKGROUND

This specification relates to using neural networks to generate output sequences.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a neural network system implemented as computer programs on one or more computers in one or more locations that generates output sequences using a token processing neural network and one or more external tools.

In general, one innovative aspect of the subject matter described in this specification can be embodied in methods that include the actions of receiving a request from a user for an output sequence; generating, using a token processing neural network, a first partial output sequence and an external tool request sequence, wherein the external tool request sequence includes tokens that represent a plurality of requests for one or more external tools, and wherein the plurality of requests includes a first request and a second request; obtaining a first result from an external tool corresponding to the first request before obtaining a second result from an external tool corresponding to the second request; generating, using the token processing neural network, based on the first partial output sequence and the first result, a second partial output sequence; providing the second partial output sequence and the first partial output sequence for presentation to the user before obtaining the second result from the external tool corresponding to the second request; obtaining the second result from the external tool corresponding to the second request; generating, using the token processing neural network, based on the second partial output sequence and the second result, a third partial output sequence; and providing the third partial output sequence, the second partial output sequence, and the first partial output sequence for presentation to the user.

Another innovative aspect of the subject matter described in this specification can be embodied in methods that include the actions for training the token processing neural network the method comprising: generating a training dataset that includes a plurality of training sequences, each training sequence comprising a plurality of tokens; and training a token processing neural network on training sequences obtained from the training dataset based on optimizing a language modeling objective.

A further innovative aspect of the subject matter described in this specification can be embodied in methods that include the actions for training a token processing neural network that has parameters, the method comprising: generating, by the token processing neural network, a plurality of training output sequences, each training output sequence comprising a plurality of tokens, the plurality of tokens comprising special tokens representing a request for an external tool; for each of the plurality of training output sequences, determining a reward score for the training output sequence that is dependent on relative positions of the special tokens within the plurality of tokens included in the training output sequence; and training the auto-regressive token processing neural network based on the plurality of training output sequences to update values of the parameters of the auto-regressive token processing neural network through reinforcement learning to optimize the reward scores.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. Obtaining the first result from the external tool corresponding to the first request before obtaining the second result from the external tool corresponding to the second request includes: the first request to the external tool corresponding to the first request as a same time as submitting the second request to the external tool corresponding to the second request; and executing the first request to the external tool corresponding to the first request in parallel with executing the second request to the external tool corresponding to the second request. Each request includes an application programming interface (API) call. The one or more external tools include one or more of: a search engine, a machine translation system, a question answering system, a calculator system, or a calendar system. The tokens that represent the plurality of requests for one or more external tools include one or more of: tokens that identify an external tool, tokens that define one or more arguments to pass to the identified external tool, or tokens that define how to use a result obtained from the identified external tool. The plurality of requests includes a third request for an external tool, and wherein the method further includes: submitting the third request to the external tool corresponding to the third request; executing the third request to the external tool corresponding to the third request; in response to determining that an amount of time taken by the external tool to execute the third request is greater than a threshold amount, generating, using the token processing neural network, and without using any results from the external tool corresponding to the third request, a fourth partial output sequence; and providing the fourth partial output sequence for presentation to the user. The training includes: obtaining a first training sequence from the training dataset, the first training sequence comprising a prefix input sequence followed by a suffix input sequence; processing, by the token processing neural network, a training input comprising the prefix input sequence and a training external tool use sequence that includes (a) tokens representing a request for a first external tool and (b) tokens representing a result from a second external tool that is different from the first external tool to generate a training output; and determining an update to values of parameters of the token processing neural network based on minimizing a difference between the training output and the suffix input sequence. The training includes obtaining a second training sequence from the training dataset, the second training sequence comprising a prefix input sequence followed by a suffix input sequence; processing, by the token processing neural network, a training input comprising the prefix input sequence and a training external tool use sequence that (a) includes tokens representing a request for a first external tool but (b) excludes tokens representing a result from any external tool to generate a training output; and determining an update to values of parameters of the token processing neural network based on minimizing a difference between training output and the suffix input sequence. For each of the plurality of training output sequences, determining the combined reward score the training output sequence includes: generating a lower reward score when the special tokens are within a threshold number of proportion of the plurality of tokens of a beginning of the training output sequence; and generating a higher reward score when the special tokens are within a threshold number of proportion of the plurality of tokens of an end of the training output sequence.

The subject matter described in this specification can be implemented in particular embodiments so as to realize one or more of the following advantages.

By streaming tokens as they are decoded, i.e., by presenting partial output sequences for display and then, as results for external tool requests are obtained, generating continuations of the partial output sequences and then presenting the continuations for display, a neural network system as described in this specification can present content related to output sequences faster than some existing systems that rely on auto-regressive neural networks and external tools, thereby improving the responsiveness of the token processing neural network and reducing the latency of an auto-regressive token generation process in comparison to those existing systems.

The ability to present an output sequence within a shorter time duration after a request has been received by a client device reduces the power consumption of a display of the client device and hence preserves battery life of the client device, because the display need not remain active for a prolonged period of time due to waiting for the output sequence to be ready for presentation. In another aspect, this improved responsiveness and reduced latency in turn enhances user experience with the described system because users can obtain information faster than they would if they were using those existing systems. That is, the described system reduces the time required for the users to wait to see information that satisfies their informational needs.

This improved responsiveness and reduced latency can also be critical for use cases that require an output quickly. In this way, the neural network system described in this specification permits real-time or near-real-time content presentation in real-world systems. For example, when implemented as part of a machine translation system, the described system can enable the machine translation system to receive an input text sequence in a first language and generate an output text sequence in a second language in real-time in order to facilitate seamless communication between two users who speak different languages.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example neural network system.

FIG. 2 is a flow diagram of an example process for generating an output sequence using a token processing neural network.

FIG. 3 is a flow diagram of another example process for generating an output sequence using a token processing neural network.

FIG. 4 is a diagram of an example training system.

FIG. 5A is a flow diagram of an example process for training a token processing neural network on a training dataset.

FIG. 5B is a flow diagram of another example process for training a token processing neural network on a training dataset.

FIG. 6 is a flow diagram of a further example process for training a token processing neural network on a training dataset.

Like reference numbers and designations in the various drawings indicate like elements.

### DETAILED DESCRIPTION

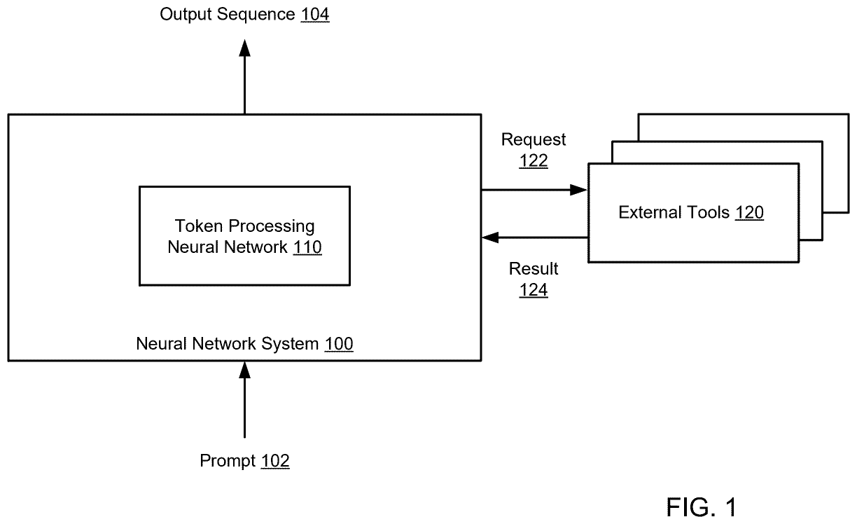

FIG. 1 is a diagram of an example neural network system 100. The neural network system 100 is an example of a system implemented as computer programs on one or more computers in one or more locations, in which the systems, components, and techniques described below can be implemented.

The neural network system 100 is a system that generates output sequences 104 in response to prompts 102. For example, the prompt 102 can be an input submitted to the neural network system 100 by a user through an input device that requires a response in the form of an output sequence 104 from the neural network system 100.

In some cases, the neural network system 100 receives the prompt 102 as text from the input device. In some cases, the neural network system 100 receives the prompt 102 as part of a multi-model input from the input device. In general, a multi-modal input is a combination of two or more different types of data, e.g., two or more of text data, audio data, image data, or graph data. As one example the multi-modal input may include a combination of i) text data representing text in a natural language and ii) pixels of an image or of video or audio data representing values of an audio waveform.

In some other cases, the neural network system 100 receives a natural language speech input from the user and converts the speech into the prompt 102 by applying a speech recognition engine to the speech. The prompt 102 may be received in the form of a sound (speech) signal, captured by a microphone input device, which is converted by a speech recognition engine, i.e., a speech-to-text converter to form the prompt. Alternatively, the prompt 102 may be entered by typing using a keyboard input device.

In some cases, the neural network system 100 can be a text generation system that performs text generation tasks by generating text sequences, i.e., each output sequence 104 generated by the neural network system 100 is a sequence of tokens from a vocabulary of text tokens that includes, e.g., one or more of characters, sub-words, words, punctuation marks, numbers, or other symbols that appear in natural language text. For example, the neural network system 100 can generate text sequences in response to received prompts 102 and provide the text sequences for presentation to users, e.g., on a display of a client device of the user or another display device that is connected to the neural network system 100.

As some general examples, the text generation task can be a natural language processing or understanding task, e.g., an entailment task, a paraphrase task, a textual similarity task, a sentiment task, a sentence completion task, a grammaticality task, and so on, that operates on a prompt that includes an input sequence of text in some natural language to generate an output sequence of text that is also in some natural language.

As a particular example, the neural network system 100 can be part of a question-answering system, where the prompt includes an input sequence of text that identifies a question and the output sequence of text represents an answer to the question. For example, the question can be provided by a user of the neural network system 100, e.g., by providing the input sequence of text directly to the system or by providing audio data representing a verbalization of the input sequence of text to the system.

As another particular example, the neural network system 100 can be part of a fact-checking system, where the prompt includes an input sequence of text that represents a statement and the output sequence of text represents a prediction about whether the statement is factually true.

As another particular example, the neural network system 100 can be part of a dialog system and the prompt can include audio or text from the most recent conversational turn submitted by a user of the dialog system during the dialog while the output sequence is the next turn in the conversation, e.g., either text or audio that is a response to the most recent conversational turn. Optionally, the prompt can also include one or more historical conversational turns that occurred earlier in the conversation.

As another particular example, the neural network system 100 can be part of a machine translation system and the prompt can include text in a source language while the output sequence is text in a target language that is a translation of the source text into the target language.

As another particular example, the neural network system 100 can be part of a computer code generation system and the prompt can be a text description of a desired piece of code or a snippet of computer code in a programming language and the output sequence can be computer code, e.g., a snippet of code that is described by the prompt or a snippet of code that follows the prompt in a computer program.

As another particular example, the neural network system 100 can be part of a search system that facilitates searching of resources on the Internet. A resource can be any data that can be provided over the Internet. A resource can be identified by a resource address that is associated with the resource. Resources include web pages, word processing documents, portable document format (PDF) documents, images, video, and news feed sources, to name a few.

In this particular example, the search system can receive search queries submitted by client devices and, in response, identify resources that are relevant to the search query in the form of search results and return the search results to the user devices in search results pages. A search result page can include search result data generated by the search system that identifies a resource responsive to a search query, and includes a link to the resource. The search result page can additionally include an output sequence that is generated by the neural network system 100 based on a prompt derived from the search query.

As another particular example, the neural network system 100 can be part of an automated assistance system, where the prompt includes an instruction in some natural language for a virtual agent (also known as “automated assistant” or “mobile assistant”) to perform a task (e.g., to complete the form on a website or send an email to a recipient), and the output sequence defines one or more actions that should be taken in a suitable execution environment, e.g., a runtime environment or an operating system environment, that is implemented on one or more client devices such as smart phones, tablet computers, wearable devices, automobile systems, standalone personal assistant devices, or any other appropriate electronic device, in order to perform the task in response to the instruction. For example, the actions can include any activity or operation that may be performed or initiated by the user on the client device, e.g., within an application software installed on the client device.

To generate the output sequences 104, the neural network system 100 uses a token processing neural network 110 and one or more external tools 120. The one or more external tools 120 are separate from the token processing neural network 110 and, in some implementations, separate, e.g., remote, from the neural network system 100. For example, an external tool 120 can be implemented in a remote server system that is separate from the neural network system 100.

An external tool 120 can generally be any software that is accessible by the neural network system 100 and that is queryable, e.g., by the neural network system 100, to provide data in response to a query. Examples of these external tools 120 include a search engine (e.g., an Internet search engine or a different search engine), a machine translation system, a question answering system, a calculator system, a calendar system, to name just a few.

The token processing neural network 110 can be any appropriate neural network that receives an input sequence made up of tokens selected from a vocabulary of tokens and generates an output sequence made up of tokens selected from the vocabulary of tokens. The vocabulary of tokens can include any of a variety of text tokens that represent text symbols or other symbols. For example, the vocabulary of tokens can include one or more of characters, sub-words, words, punctuation marks, numbers, or other symbols that appear in a corpus of text in a natural language and/or a computer programming language.

For example, the token processing neural network 110 can have a Transformer-based neural network architecture or a recurrent neural network architecture. As a particular example, the token processing neural network 110 can be an auto-regressive Transformer-based neural network that has, e.g., an encoder-only Transformer architecture, an encoder-decoder Transformer architecture, or a decoder-only Transformer architecture.

The token processing neural network 110 is referred to as an auto-regressive neural network because the token processing neural network 110 auto-regressively generates an output sequence of tokens by generating each particular token in the output sequence conditioned on a current input sequence that includes any tokens that precede the particular token in the output sequence, i.e., the tokens that have for already been generated for any previous positions in the output sequence that precede the particular position of the particular token.

For example, when generating a token at any given position in the output sequence, the current input sequence can include the received prompt 102 and the tokens at any preceding positions that precede the given position in the output sequence. As a particular example, the current input sequence can include the prompt followed by a current output sequence that includes the tokens at any preceding positions that precede the given position in the output sequence. Optionally, the prompt and the current output sequence can be separated by one or more predetermined tokens within the current input sequence.

More specifically, to generate a particular token at a particular position within an output sequence, the token processing neural network 110 can process the current input sequence to generate a score distribution, e.g., a probability distribution, that assigns a respective score, e.g., a respective probability, to each token in the vocabulary of tokens. The token processing neural network 110 can then select, as the particular token, a token from the vocabulary using the score distribution. For example, the token processing neural network 110 can greedily select the highest-scoring token or can sample, e.g., using nucleus sampling or another sampling technique, a token from the distribution.

As a particular example, the token processing neural network 110 can be an auto-regressive Transformer-based neural network that includes (i) a plurality of attention blocks that each apply a self-attention operation and (ii) an output subnetwork that processes an output of the last attention block to generate the score distribution.

Examples of such architectures include those described in Colin Raffel, et al. Exploring the limits of transfer learning with a unified text-to-text transformer. arXiv preprint arXiv:1910.10683, 2019; Daniel Adiwardana, et al. Towards a human-like open-domain chatbot. CoRR, abs/2001.09977, 2020; Tom B Brown, et al. Language models are few-shot learners. arXiv preprint arXiv:2005.14165, 2020; Aakanksha Chowdhery, et al. PaLM: Scaling Language Modeling with Pathways, arXiv preprint arXiv:2204.02311; and Rohan Anil, et al. Palm 2 technical report. arXiv preprint arXiv:2305.10403, 2023.

Generally, however, the Transformer-based neural network includes a sequence of attention blocks, and, during the processing of a given input sequence, each attention block in the sequence receives a respective input hidden state for each input token in the given input sequence. The attention block then updates at least the hidden state for the last token in the given input sequence at least in part by applying self-attention to generate a respective output hidden state for the last token. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

To make use of the one or more external tools 120, the token processing neural network 110 is configured to generate an output sequence 104 by generating both (i) one or more partial output sequences that each include tokens that will be included in the output sequence 104 and (ii) one or more external tool request sequences that each include tokens that represent one or more requests 122 for the one or more external tools 120.

For example, each request 122 can include an application programming interface (API) call from the neural network system 100 to an application programming interface (API) that is made available by a corresponding external tool 120. Each request 122 to an external tool 120 may expect some data in the form of a result 124 from the external tool 120.

That is, the tokens included in a partial output sequence will be included as-is in the output sequence 104 that is being generated by the token processing neural network 110 in response to the prompt 102. On the other hand, the tokens included in an external tool request sequence will typically not be included as-is in the output sequence 104. In place of the external tool request sequence, the output sequence 104 will include a result 124 that is received from an external tool 120 in response to a request 122 that is represented by the tokens included in the external tool request sequence.

When performing inference to generate an output sequence 104, after an external tool request sequence that includes tokens representing one or more requests 122 for one or more external tools 120 has been generated by the token processing neural network 110, the neural network system 100 executes the requests 122 to receive one or more results 124 from the one or more external tools 120, and the token processing neural network 110 proceeds to generate a partial output sequence to be used as an additional portion of the output sequence 104.

To represent a request 122 for an external tool 120, the external tool request sequence can include one or more of: (i) tokens that identify the external tool 120, (ii) tokens that define one or more arguments to pass to the identified external tool 120, or, (iii) tokens that define how to use a result 124 obtained from the identified external tool 120, i.e., at which position or in which form should the result 124 be incorporated within the output sequence that is being generated by the token processing neural network 110.

For example, the external tool request sequence can include tokens that identify a name of the external tool 120, followed by tokens that define one or more arguments to pass to the external tool 120, and, optionally, followed by tokens that define how a result 124 obtained from the external tool 120 should be incorporated into the output sequence. Optionally, but not necessarily, the tokens that define one or more arguments to pass to the external tool can be separated from other tokens by one or more predetermined tokens, e.g., the parentheses tokens or quotation mark tokens, within the external tool request sequence.

To distinguish from the partial output sequences that do not represent such a request for an external tool, in some implementations, the external tool request sequence can be surrounded by predetermined tokens, e.g., the “<API>” and “</API>” tokens, or the “[” and “]” tokens. That is, each external tool request sequence can begin and end with predetermined tokens that indicate to neural network system 100 that these tokens represent the request for the external tool 120 (and thus should not be included as-is in the output sequence 104).

As a particular example, to represent a request for an external tool that is a question answering system, an external tool request sequence can be in the form of:
“<API> QA(“Who is the publisher of The New England Journal of Medicine?”)→</API>”.

In this example, “QA” are tokens that identify the question answering (QA) system, “Who is the publisher of The New England Journal of Medicine?” are tokens that define the argument to pass to the question answering system, and “→” are tokens that define that, once obtained in response to the request, the result (“Massachusetts Medical Society”) should be placed within the output sequence at the position indicated by “→”.

The “→” tokens are optional. When they are not included, the external tool request sequence can be in the form of:
“<API> QA(“Who is the publisher of The New England Journal of Medicine?”) </API>”.

As another particular example, to represent a request for an external tool that is a calculator system, an external tool request sequence can be in the form of:

$$“ < API > Calculator ( 400 / 1400 ) \to \text{</} API > ”$$

In this example, “Calculator” are tokens that identify the calculator system, “400/1400” are tokens that define the argument to pass to the calculator system, and “→” are tokens that define that, once obtained in response to the request, the result (“0.29”) should be placed within the output sequence at the position indicated by “→”.

As yet another particular example, to represent a request for an external tool that is a search engine, an external tool request sequence can be in the form of:
“<API> Search(“Brown Act”)→</API>”

In this example, “Search” are tokens that identify the search engine, “Brown Act” are tokens that define the argument to pass to the search engine, and “→” are tokens that define that, once obtained in response to the request, the result (“The Ralph M. Brown Act is an act of the California State Legislature that guarantees the public's right to attend and participate in meetings of local legislative bodies”) should be placed within the output sequence at the position indicated by “→”.

Thus, by virtue of generating external tool request sequences representing requests 122 for the one or more external tools 120 which, in turn, cause the neural network system 100 to make use of the one or more external tools 120 to obtain data that includes the results 124, the token processing neural network 110 is able to generate output sequences 104 that incorporate the results 124 provided by the one or more external tools 120. Generally, the use of the one or more external tools 120 enable the token processing neural network 110 to generate higher quality (e.g., more accurate, more relevant, more comprehensive, or the like) output sequences 104 in response to the prompts 102.

In practice, after an external tool request sequence that includes tokens representing one or more requests 122 for one or more external tools 120 has been generated by the token processing neural network 110, the neural network system 100 halts the auto-regressive token generation process, executes the one or more requests 122 for the one or more external tools 120, receives the one or more results 124 from the one or more external tools 120, and resumes the auto-regressive token generation process to generate a partial output sequence to be used as an additional portion of the output sequence 104.

In particular the neural network system 100 halts the auto-regressive token generation process because the system needs to feed the results 124 back as input to the token processing neural network 110 so that the neural network can generate the remaining tokens conditioned on the results 124 and rather than on the requests 122.

For example, the token processing neural network 110 can generate the beginning token in the partial output sequence conditioned on a current input sequence that includes the prompt 102, the tokens at any preceding positions in the output sequence that precede the position occupied by the beginning token in the partial output sequence, and the one or more results 124 from the one or more external tools 120. Optionally, but not necessarily, the current input sequence also includes the external tool request sequence.

In other words, when performing inference to generate an output sequence, whenever an external tool request sequence has been generated, the auto-regressive token generation process using the token processing neural network 110 will be temporarily halted until a later time, e.g., until after a result 124 for the request 122 is received from the external tool 120 by the neural network system 100.

Because the external tools 120 are separate from the token processing neural network 110 and, in some implementations, separate, e.g., remote, from the neural network system 100, however, there can be a number of issues that arise when interacting with the external tools 120 by way of API calls, negatively impacting the capability of the token processing neural network 110 in generating output sequences and also the performance of the neural network system 100.

For one, the roundtrip time of the API calls can be lengthy. In other words, an elapsed time between the transmitting a request 122 to an external tool 120 and receiving a result 124 from the external tool 120 in response to the request can be noticeably long, e.g., longer than Is, 2s, or 5s. A lengthy roundtrip time of the API calls increases the inference latency of the token processing neural network 110 in generating output sequences.

For another, an API call may not always result in a response that is being requested actually being provided, i.e., a result 124 may not be received in response to every request 122. This can be because, for example, 5xx server errors, library exceptions, or other types of errors that result in failure of an external tool 120 to accomplish a goal of an API call.

As a particular example of this, when an amount of time taken by the external tool 120 to provide a result 124 in response to a request 122 is greater than a threshold amount of time, the request 122 may be aborted and the best-effort result, e.g., without the actual result 124, will be returned as a response to the request 122.

Nonresponsive API calls negatively impact the capability of the token processing neural network 110 in generating complete output sequences, e.g., it may instead generate output sequences that are truncated to exclude the result 124 and any subsequent tokens that could be generated based on the result 124.

To improve the performance of the neural network system 100 when generating an output sequence in response to a prompt 102, the token processing neural network 110 of FIG. 1 is configured to generate tokens that make up the output sequence 104 in ways that account for these issues.

More specifically, the token processing neural network 110 is configured to, when an output sequence 104 to be generated by the neural network needs a single result 124 from one of the external tools 120, postpone the generation of an external tool request sequence that includes tokens representing a corresponding request 122 as late as possible during the auto-regressive token generation process, such that tokens representing the request 122 for the external tool 120 are included within a first threshold number or a first threshold proportion of tokens at the end of the output sequence.

Stated another way, tokens representing the request 122 for the external tool 120 are preceded by a second threshold number or a second threshold proportion of tokens at the beginning of the output sequence, where the second threshold number (or the first threshold proportion) is greater, in some cases much greater, than the first threshold number (or first threshold proportion). For example, the tokens representing the request 122 for the external tool 120 are included within the last N tokens of the output sequence 104 or the last P/Q tokens of the output sequence 104, where Q and N are each a respective integer and Q>>N, and P is a percentage no greater than 50%, in some cases no greater than 40%, 25%, or less.

The token processing neural network 110 is also configured to, when an output sequence 104 to be generated by the neural network needs multiple results 124 from, e.g., the same or different ones of, the one or more external tools 120, generate an external tool request sequence that includes tokens representing multiple corresponding requests 122 as a grouping to facilitate at least partially parallel API calls to one or more of the external tools 120, and then generate one or more partial output sequences as the results 124 are received one after another from the external tools 120 in response to the requests 122.

In the case of having generated an external tool request that includes tokens that represent multiple requests 122, the token processing neural network 110 does not wait until the results 124 for all of the multiple requests 122 are received before resuming the auto-regressive token generation process. Instead, it begins generating tokens that make up a partial output sequence as soon as the result 124 for one of the multiple requests 122 has been received.

Note that the order in which the results 124 are received by the neural network system 100 may or may not be the same as the order in which the corresponding requests 122 are defined by the external tool request sequence generated by the token processing neural network 110.

For example, the token processing neural network 110 can generate an external tool request sequence that includes a first plurality of tokens representing a first request followed by a second plurality of tokens representing a second request, causing the neural network system 100 to execute the first and second requests at least partially in parallel with each other.

Suppose that a second result corresponding to the second request is received before a first result corresponding to the first request, the token processing neural network 110 can begin generating tokens that make up a partial output sequence as soon as the second result is received and before the first result is received (despite that the first plurality of tokens representing the first request is generated preceding the first second of tokens representing the second request).

The token processing neural network 110 is further configured to, when an output sequence 104 to be generated by the neural network needs a result 124 from one of the external tools 120, resume the auto-regressive token generation process to generate a partial output sequence whenever the result 124 is not received after a threshold amount of time since the execution of a request 122. This threshold amount of time can be counted by a timer. The timer can for example be started upon the neural network system 100 submitting a request 122 to an external tool 120 in accordance with an external tool request sequence that includes tokens representing the request 122 that is generated by the token processing neural network 110.

After the threshold amount of time has elapsed without receiving any result 124 from the external tool 120 in response to the request 122, the token processing neural network 110 begins to generate tokens that make up a partial output sequence without incorporating the result 124.

For example, the token processing neural network 110 can generate the beginning token in the partial output sequence conditioned on a current input sequence that includes the prompt 102, the tokens at any preceding positions in the output sequence that precede the position occupied by the beginning token in the partial output sequence, and the external tool request sequence (but less the actual result 124). In some cases, the neural network system 100 can provide one or more predetermined placeholder tokens that indicate that the actual result 124 is missing, and the token processing neural network 110 can generate the beginning token in the partial output sequence conditioned on a current input sequence that additionally includes the one or more predetermined placeholder tokens.

As the tokens that make up the output sequence 104 are being generated by the token processing neural network 110, the neural network system 100 can provide the tokens for presentation to a user on a display device. Because of the configuration of the token processing neural network 110 mentioned above, content related to the output sequence 104 can be presented for display faster than some existing systems that rely on auto-regressive neural networks and external tools, thereby improving the responsiveness of the token processing neural network 110 and reduces the latency of an auto-regressive token generation process in comparison to those existing systems.

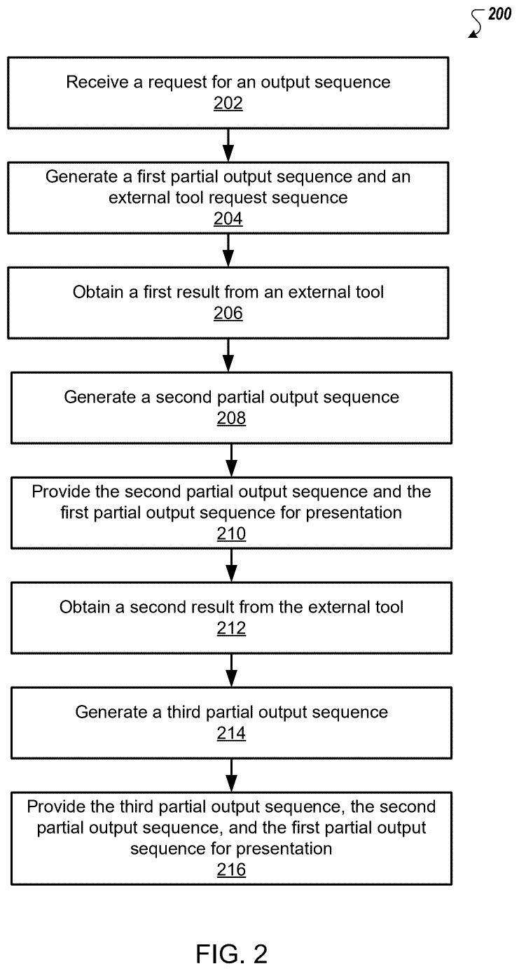

FIG. 2 is a flow diagram of an example process 200 for generating an output sequence using a token processing neural network. For convenience, the process 200 will be described as being performed by a system of one or more computers located in one or more locations. For example, a neural network system, e.g., the neural network system 100 of FIG. 1, appropriately programmed in accordance with this specification, can perform the process 200.

The system receives a request for an output sequence (step 202). For example, the system can receive the request as an input submitted by a user of the system through an input device. In some implementations, the system can receive a prompt as part of or in association with the request. The prompt provides context for the output sequence.

The system generates, using the token processing neural network, a first partial output sequence and an external tool request sequence (step 204). The first partial output sequence includes a first plurality of tokens. The first plurality of tokens included in the first partial output sequence will be included as-is in the output sequence that is being generated by the system in response to the request.

The external tool request sequence includes tokens that represent a plurality of requests for one or more external tools. The plurality of requests represented by the external tool request can include a first request and a second request. The first request and the second request can either be for the same external tool or alternatively be for different external tools.

For example, each request can include an application programming interface (API) call to an application programming interface (API) that is made available by a corresponding external tool. To represent a request for an external tool, the external tool request sequence can include one or more of: (i) tokens that identify the external tool, (ii) tokens that define one or more arguments to pass to the identified external tool, or, (iii) tokens that define how to use a result obtained from the identified external tool, i.e., at which position or in which form should the result be incorporated within the output sequence.

For example, the system receives the following prompt: “write a short description of the City of Pittsburgh.” In response, the system generates a first partial output sequence: “Pittsburgh is known as” and an external tool request sequence that includes tokens that represent a first request: “<API> QA1(“What other name is Pittsburgh known by?”)→</API>” and tokens that represent a second request: “<API> QA2(“What is Pittsburgh known as?”)→</API>”.

The system executes the plurality of requests represented by the external tool request sequence to obtain the corresponding results from the one or more external tools (step 206). Executing a request can involve submitting the API call included in the request from the system to a corresponding external tool.

As the plurality of requests are being executed (and prior to receiving any result in response to the plurality of requests), the system halts the auto-regressive token generation process, such that no further tokens are being generated. For example, no further tokens beyond “Pittsburgh is known as”, “<API> QA1(“What other name is Pittsburgh known by?”)→</API>”, and “<API> QA2(“What is Pittsburgh known as?”)→</API>” are being generated in the example above.

The plurality of requests including the first request and the second request can be executed at least partially in parallel with each other. For example, the system can submit the API call included in the first request to the external tool corresponding to the first request at the same (or substantially the same) time as submitting the API call included in the second request to the external tool corresponding to the second request, thereby causing the external tool corresponding to the first request to execute the first request at least partially in parallel with the external tool corresponding to the second request executing the second request.

In spite of this, the system obtains a first result from an external tool corresponding to the first request before obtaining a second result from the external tool corresponding to the second request. That is, the first API call included in the first request is executed faster than the second API call included in the second request.

In practice this can happen for a variety of reasons. For example, this can occur because a remote server system that implements the external tool corresponding to the first request has more powerful processing units. As another example, this can occur because a network that connects the system and the remote server system that implements the external tool corresponding to the first request has greater network bandwidth. As another example, this can occur simply because the first API call is easier to execute than the second API call.

The system generates, using the token processing neural network and based on the first partial output sequence and the first result, a second partial output sequence (step 208). That is, the system resumes the auto-regressive token generation process now that the first request has been obtained.

The second partial output sequence includes a second plurality of tokens. Like the first partial output sequence, the second plurality of tokens included in the second partial output sequence will be included as-is in the output sequence that is being generated by the system in response to the request.

To generate the second partial output sequence, the system can perform incremental prompting of the token processing neural network given the first partial output sequence that has already been generated and the first result that has been returned so far in response to the plurality of requests.

For example, the token processing neural network can generate the beginning token in the second partial output sequence conditioned on a current input sequence that includes (i) the prompt, (ii) the first plurality of tokens included in the first partial output sequence, and (iii) the first result obtained from the external tool corresponding to the first request. Optionally, but not necessarily, the current input sequence also includes the external tool request sequence.

For example, the system obtains a first result: “the Steel City” from a first question answer system corresponding to first request before obtaining a second result: “the City of Bridges” from a second question answer system corresponding to the second request. Then, the system generates a second partial output sequence: “for its dominant role in the history of the U.S. steel industry. Pittsburgh is known as”.

The system provides the second partial output sequence and the first partial output sequence for presentation to the user on a display device, before obtaining the second result from the external tool corresponding to the second request (step 210). In some implementations, the second partial output sequence follows the first partial output sequence. For example, the second partial output sequence can be a continuation of the first partial output sequence.

For example, the system provides the following output sequence for presentation to the user on the display device: “Pittsburgh is known as the Steel City for its dominant role in the history of the U.S. steel industry. Pittsburgh is also known as”.

In doing so, the system can present content related to the output sequence faster than some existing systems that rely on auto-regressive neural networks and external tools. For example, despite that the same external tools are used, those existing systems would have presented no or less content related to the output sequence by the time the above output sequence is presented for display in response to the same prompt of “write a short description of the City of Pittsburgh” because they could still be waiting for the second result for the second request to return from the external tool before resuming the auto-regressive token generation process. In another aspect, the system improves the responsiveness of the token processing neural network and reduces the latency of the auto-regressive token generation process in comparison to those existing systems. This improved responsiveness and reduced latency in turn enhances user experience with the system.

The system obtains the second result from the external tool corresponding to the second request (step 212). That is, the second result is obtained after the second partial output sequence and the first partial output sequence have already been provided for presentation to the user.

The system generates, using the token processing neural network and based on the second partial output sequence and the second result, a third partial output sequence (step 214). The third partial output sequence includes a third plurality of tokens. Like the first and second partial output sequences, the third plurality of tokens included in the third partial output sequence will be included as-is in the output sequence that is being generated by the system in response to the request.

To generate the third partial output sequence, the system can perform incremental prompting of the token processing neural network given the first and second partial output sequences that have already been generated and the second result that has now been returned in response to the plurality of requests.

For example, the token processing neural network can generate the beginning token in the third partial output sequence conditioned on a current input sequence that includes (i) the prompt, (ii) the first plurality of tokens included in the first partial output sequence, (iii) the second plurality of tokens included in the second partial output sequence, and (iv) the second result obtained from the external tool corresponding to the second request. Optionally, but not necessarily, the current input sequence also includes the external tool request sequence.

For example, after having presented “Pittsburgh is known as the Steel City for its dominant role in the history of the U.S. steel industry. Pittsburgh is known as” for presentation to the user on the display device, and after having obtained the second result: “the City of Bridges” from the second question answer system corresponding to the second request, the system then generates a third partial output sequence: “because it has 144 active bridges that span and climb the uneven terrain of rivers, runs, and valleys.”

The system provides the third partial output sequence, the second partial output sequence, and the first partial output sequence for presentation to the user on the display device (step 216). In some implementations, the third partial output sequence follows the second partial output sequence, which, in turn, follows the first partial output sequence. For example, the third partial output sequence can be a continuation of the second partial output sequence which, in turn, can be a continuation of the first partial output sequence.

For example, the system provides the following output sequence for presentation to the user on the display device: “Pittsburgh is known as the Steel City for its dominant role in the history of the U.S. steel industry. Pittsburgh is also known as the City of Bridges because it owns 144 active bridges that span and climb the uneven terrain of rivers, runs, and valleys.”

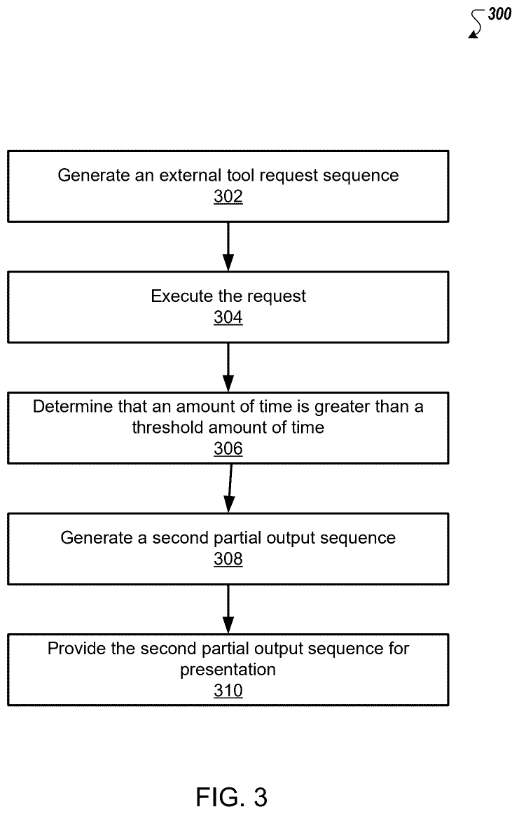

FIG. 3 is a flow diagram of another example process 300 for generating an output sequence using a token processing neural network. For convenience, the process 300 will be described as being performed by a system of one or more computers located in one or more locations. For example, a neural network system, e.g., the neural network system 100 of FIG. 1, appropriately programmed in accordance with this specification, can perform the process 300.

The system generates, using the token processing neural network, an external tool request sequence (step 302). The external tool request sequence includes tokens that represent a request for an external tool. The external tool request sequence can be part of an output sequence being generated by the system in response to a prompt. For example, the output sequence can also include a first partial output sequence that precedes the external tool request sequence.

For example, the system generates a first partial output sequence: “The WL will be open on this Friday” followed by an external tool request sequence: “<API> Calendar(“Today is Thursday, March 9, 2017”)→</API>”. In this example, the result that is expected to be returned from an external tool that is a calendar system in response to the request is “March 10, 2017”.

The system executes the request represented by the external tool request sequence to attempt to obtain a corresponding result from the external tool (step 304). Executing a request can involve submitting the API call included in the request from the system to the external tool. As the request is being executed (and prior to receiving the corresponding result from the external tool), the system halts the auto-regressive token generation process, such that no further tokens (beyond what have already been generated) are being generated.

The system determines that an amount of time taken by the external tool to execute the request is greater than a threshold amount of time (step 306). The amount of time can be counted by a timer. The timer can for example be started upon the system submitting the API call included in the request to the external tool.

In practice this can happen for a variety of reasons. For example, this can occur because a remote server system that implements the external tool corresponding to the request is offline, e.g., no connectivity exists between the system and the remote server system. As another example, this can occur because incorrect information (e.g., incorrect payload or incorrect body) is included in the API call. As another example, this can occur simply because the API call is a complex one that takes a significant amount of time to execute.

In response to determining that an amount of time taken by the external tool to execute the request is greater than the threshold amount, the system generates, using the token processing neural network, and without using any result from the external tool corresponding to the request, a second partial output sequence (step 308). That is, the system resumes the auto-regressive token generation process despite that the result that should be obtained from the external tool is in fact not obtained.

For example, the token processing neural network can generate the beginning token in the second partial output sequence conditioned on a current input sequence that includes (i) the prompt, (ii) the partial output sequence, and (iii) the external tool request sequence (but less the actual result). In some cases, the system can provide one or more predetermined placeholder tokens that indicate that the actual result is missing, and the token processing neural network can generate the beginning token in the partial output sequence conditioned on a current input sequence that additionally includes the one or more predetermined placeholder tokens.

For example, in response to determining that an amount of time taken by the calendar system to execute the request is greater than the threshold amount, the system generates a second partial output sequence: “for regular hours.”

The system provides the second partial output sequence for presentation to the user on a display device (step 310). When the output sequence also includes the first partial output sequence, the system can provide the second partial output sequence followed by the first partial output sequence for presentation to the user.

For example, the system provides the following output sequence for presentation to the user on the display device: “The WL will be open on this Friday for regular hours.” Note that, on the contrary, assuming that the result (“March 10, 2017”) has been obtained in time, the system could generate and present the following output sequence for presentation to the user on the display device: “The WL will be open on this Friday March 10, 2017 for regular hours.” In doing so, the system can present content related to the output sequence faster than some existing systems that rely on auto-regressive neural networks and external tools. For example, despite that the same external tool is used, those existing systems would have presented no or less content related to the output sequence by the time the above output sequence is presented for display because they could still be waiting for the result for the request to return from the external tool before resuming the auto-regressive token generation process. In another aspect, the system improves the responsiveness of the token processing neural network and reduces the latency of the auto-regressive token generation process in comparison to those existing systems. This improved responsiveness and reduced latency in turn enhances user experience with the system.

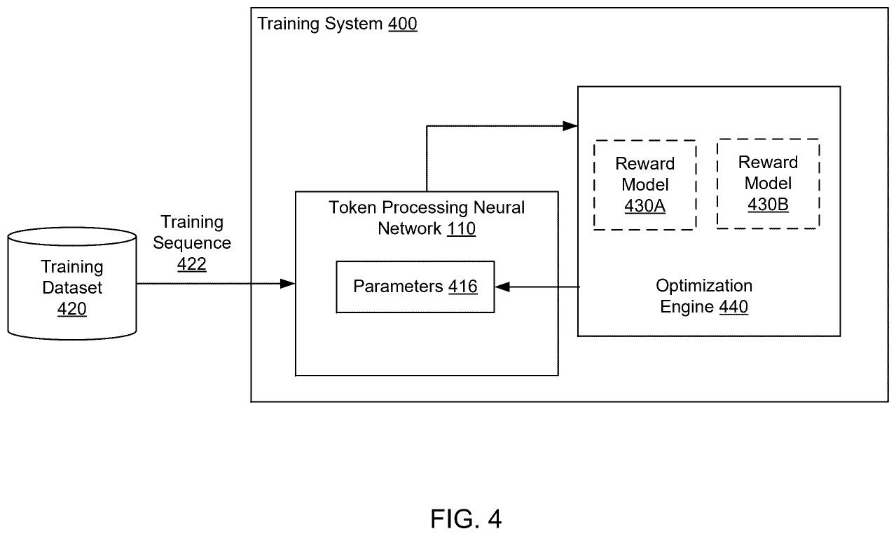

FIG. 4 is a diagram of an example training system 400. The training system 400 is an example of a system implemented as computer programs on one or more computers in one or more locations that trains the token processing neural network 110 that has parameters 416 on a training dataset 420 to determine fine-tuned values of the parameters 416 of the token processing neural network 110.

After training, the training system 400 can output data specifying the trained token processing neural network 110, e.g., data specifying the trained values of the parameters 416, to the neural network system 100 of FIG. 1 to deploy the token processing neural network 110 in the neural network system 100 to perform inference, i.e., to generate output sequences 104 in response to prompts 102.

The training dataset 420 includes a plurality of training sequences 422. Each training sequence 422 includes a prefix input sequence followed by a suffix input sequence. The prefix input sequence and the suffix input sequence can each include a respective subset of a plurality of tokens included in the training sequence 422.

In some cases, the training dataset 420 also includes, for each training sequence 422, a training external tool use sequence that corresponds to the training sequence 422. Each training external tool use sequence includes (a) tokens representing a request for an external tool and (b) tokens representing a result that should be obtained from the external tool in response to the request.

For example, the training dataset 420 includes the following training sequence: “Joe Biden was born in Scranton, Pennsylvania”, where the prefix input sequence is: “Joe Biden was born in” and the suffix input sequence is: “Scranton, Pennsylvania”. The training dataset 420 also includes the following external tool use sequence corresponding to the training sequence: “<API> QA(“Where was Joe Biden born?”)→Scranton, Pennsylvania </API>” where “QA(“Where was Joe Biden born?”→)” are tokens that represent a request for an external tool that is a question answering system, and “Scranton, Pennsylvania” are tokens that represent a result that should be obtained from the external tool in response to the request.

The token processing neural network 110 is typically trained using a two-stage approach: a pre-training stage followed by a fine-tuning stage, where at least the fine-tuning stage takes place at the training system 400. For example, the training system 400 can receive data specifying a pre-trained token processing neural network 110 from another system, and then perform the fine-tuning of the pre-trained token processing neural network 110.

In the pre-training stage, the token processing neural network 110 is pre-trained by the training system 400 or another system based on optimizing one or more unsupervised or self-supervised objective functions, e.g., a maximum-likelihood objective function or another language modeling objective function, on a large dataset of text in one or more natural languages, e.g., text that is publicly available from the Internet or another text corpus. Optionally the pre-training stage also involves using labeled data to train the token processing neural network 110 on output sequence generation tasks.

In the fine-tuning stage, the pre-trained token processing neural network 110 is then adjusted to the output sequence generation tasks through fine-tuning adaptation. Examples of fine-tuning adaptation technique include supervised fine-tuning (SFT), reinforcement learning from human feedback (RLHF), reinforcement learning from AI feedback (RLAIF), prompt tuning, instruction tuning, and the like, that use different training objectives, different data, or both.

As part of this fine-tuning, the training system 400 trains the token processing neural network 110 over multiple fine-tuning training steps to repeatedly update the values of the parameters 116 of the token processing neural network 110, i.e., to generate fine-tuned values of the parameters 116 from their pre-trained values that have been determined as a result of the pre-training.

At each of some of the multiple fine-tuning training steps, the training system 400 uses the token processing neural network 110 to generate a batch of training outputs based on a batch of training sequences 422 and their corresponding training external tool use sequences obtained from the training dataset 420.

The training system 400 then uses an optimization engine 440 to update the values of the parameters 416 of the token processing neural network 110 based on optimizing a fine-tuning objective function that includes a term dependent on a difference between (i) each training output generated by the token processing neural network 110 and (ii) the suffix input sequence included in a corresponding training sequence 422 in the batch of training sequences 422 obtained from the training dataset 420.

In some cases, the training system 400 obtains a training sequence 422 and the corresponding training external tool use sequence, and then uses the token processing neural network 110 to generate a training output by processing (i) the prefix input sequence included in the training sequence 422 and (ii) the corresponding training external tool use sequence as-is, in accordance with the values of the parameters 416 of the token processing neural network 110.

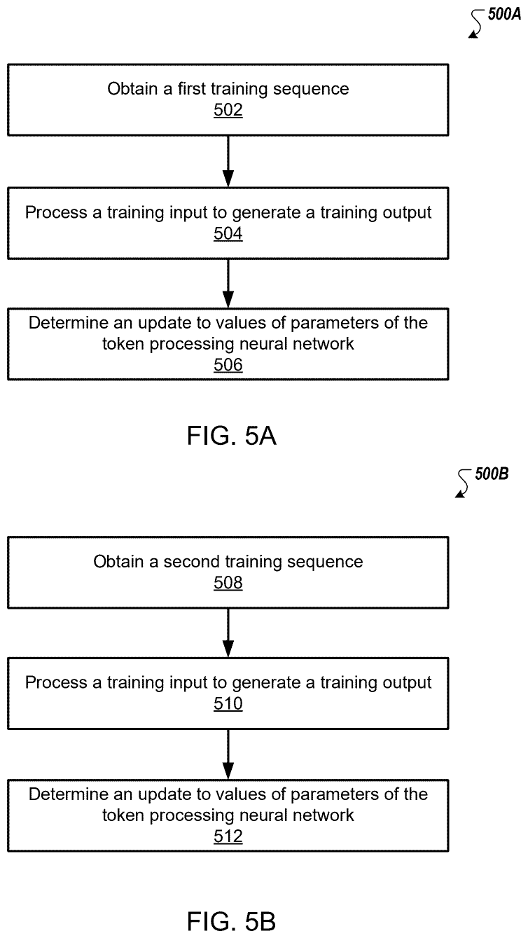

In some other cases, as will be described further below with reference to FIGS. 5A-B, the training system 400 obtains a training sequence 422 and the corresponding training external tool use sequence, modifies the training external tool use sequence in some ways that simulate the issues mentioned above that might arise in practice when interacting with external tools, and then uses the token processing neural network 110 to generate a training output by processing (i) the prefix input sequence included in the training sequence 422 and (ii) the modified training external tool use sequence, in accordance with the values of the parameters 416 of the token processing neural network 110.

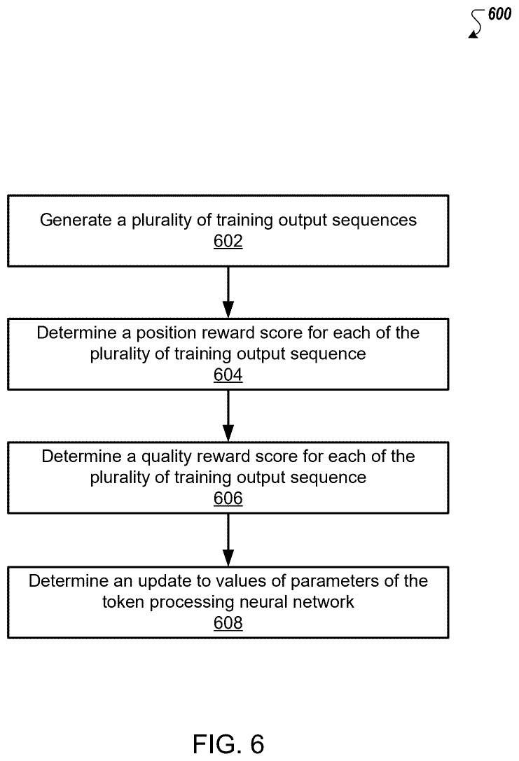

At each of some others of the multiple fine-tuning training steps, as will be described further below with reference to FIG. 6, the training system 400 uses the token processing neural network 110 to generate, in accordance with the values of the parameters 416 of the token processing neural network 110, a batch of training output sequences based on a batch of training sequences 422 obtained from the training dataset 420. Each training output sequence includes a plurality of tokens. The plurality of tokens include special tokens representing a request for an external tool and other tokens that do not represent such a request.

The training system 400 then uses an optimization engine 440 to update the values of the parameters 416 of the token processing neural network 110 based on optimizing a combined objective that includes a combination of reward scores generated by a position reward model 430A and reward scores generated by a quality reward model 430B.

For each training output sequence generated by the token processing neural network 110, the position reward model 430A is configured to process the training output sequence to generate a position reward score based on the positions of the special tokens relative to the other tokens within the training output sequence. Stated another way, a training output sequence may have a higher or lower position reward score depending on the order of special tokens and the other tokens within the training output sequence.

In some implementations, the position reward model 430A can be implemented using some deterministic algorithms that count the positions of the tokens included in a training output sequence and then computes a position reward score for the training output sequence based on the counted positions. Other implementations of the position reward model 430A are possible, too.

For each training output sequence generated by the token processing neural network 110, the quality reward model 430B is configured to process the training output sequence to generate a quality reward score based on a quality of the training output sequence. In principle the quality can be defined with respect to any aspects of the training output sequence including, for example, a conciseness, helpfulness, relevancy, completeness, and so on.

In some implementations, the quality reward model 430B can be implemented as a neural network that can have any appropriate architecture, e.g., a convolutional architecture, a fully-connected architecture, or an attention architecture, that allows the quality reward model 430B to process a training output sequence to generate a quality reward score for the training output sequence. Other implementations of the quality reward model 430B are possible, too.

FIG. 5A is a flow diagram of an example process 500A for training a token processing neural network on a training dataset. For convenience, the process 500A will be described as being performed by a system of one or more computers located in one or more locations. For example, a training system, e.g., the training system 400 of FIG. 4, appropriately programmed in accordance with this specification, can perform the process 500A.

The training dataset includes a plurality of training sequences. Each training sequence includes a prefix input sequence followed by a suffix input sequence. The prefix input sequence and the suffix input sequence can each include a respective subset of a plurality of tokens included in the training sequence.

The training dataset also includes, for each training sequence, a training external tool use sequence that corresponds to the training sequence. Each training external tool use sequence includes (a) tokens representing a request for an external tool and (b) tokens representing a result that should be obtained from the external tool in response to the request.

The system obtains a first training sequence from the training dataset (step 502). The first training sequence includes a prefix input sequence followed by a suffix input sequence. For example, the first training sequence can be included as one of a batch of training sequences obtained from the training dataset through random sampling.

The system processes, by the token processing neural network and in accordance with the values of the parameters of the token processing neural network, a training input to generate a training output (step 504). The training input includes (i) the prefix input sequence included in the first training sequence and (ii) a modified training external tool use sequence.

The modified training external tool use sequence is generated based on modifying the training external tool use sequence that is included in the training dataset and that corresponds to the training sequence in a way to simulate the issues mentioned above that might arise in practice when interacting with external tools.

In particular, the system modifies the training external tool use sequence such that the modified training external tool use sequence includes (a) tokens representing a request for a first external tool and (b) tokens representing a result from a second external tool that is different from the first external tool. In doing so the system simulates the issues where different requests take varying amounts of time to execute, and hence results may not be obtained in the order in which they are requested.

For example, the first external tool can be the actual external tool that is represented by the tokens included in the training external tool use sequence obtained from the training dataset, but the second external tool is a different external tool, and hence the result from the second external tool is not the result that should be obtained from the first external tool in response to the request.

The system determines an update to values of parameters of the token processing neural network based on optimizing a fine-tuning objective that includes a term dependent on a difference between (i) the training output and (ii) the suffix input sequence included in the first training sequence (step 506).

The system can do this by computing respective gradients of the fine-tuning objective function with respect to the parameters of the token processing neural network by backpropagation through the appropriate parameters of the neural network. The system can then determine the updates by applying an update rule, e.g., an Adam update rule, an Rmsprop update rule, or a stochastic gradient descent (SGD) update rule, to the respective gradients.

FIG. 5B is a flow diagram of another example process 500B for training a token processing neural network on a training dataset. For convenience, the process 500B will be described as being performed by a system of one or more computers located in one or more locations. For example, a training system, e.g., the training system 400 of FIG. 4, appropriately programmed in accordance with this specification, can perform the process 500B.

The training dataset includes a plurality of training sequences. Each training sequence includes a prefix input sequence followed by a suffix input sequence. The prefix input sequence and the suffix input sequence can each include a respective subset of a plurality of tokens included in the training sequence.

The training dataset also includes, for each training sequence, a training external tool use sequence that corresponds to the training sequence. Each training external tool use sequence includes (a) tokens representing a request for an external tool and (b) tokens representing a result that should be obtained from the external tool in response to the request.

The system obtains a second training sequence from the training dataset (step 508). The second training sequence includes a prefix input sequence followed by a suffix input sequence.

For example, the second training sequence can be included as one of a batch of training sequences obtained from the training dataset through random sampling.

The system processes, by the token processing neural network and in accordance with the values of the parameters of the token processing neural network, a training input to generate a training output (step 510). The training input includes (i) the prefix input sequence included in the first training sequence and (ii) a modified training external tool use sequence.

In particular, the system modifies the training external tool use sequence such that the modified training external tool use sequence (a) includes tokens representing a request for a first external tool but (b) excludes tokens representing a result that should be obtained from the first external tool or any other external tool. For example, the first external tool can be the actual external tool that is represented by the tokens included in the training external tool use sequence obtained from the training dataset, and the modified training external tool use sequence can include one or more predetermined placeholder tokens that indicate that the result corresponding to the actual external tool is missing or pending. In doing so the system simulates the issues where some requests take a significant amount of time to execute or when errors occur while executing the requests, and hence results cannot be obtained despite being requested for.

The system determines an update to values of parameters of the token processing neural network based on optimizing a fine-tuning objective that includes a term dependent on a difference between (i) the training output and (ii) the suffix input sequence included in the first training sequence (step 512).

The system can do this by computing respective gradients of the fine-tuning objective function with respect to the parameters of the token processing neural network by backpropagation through the appropriate parameters of the neural network. The system can then determine the updates by applying an update rule, e.g., an Adam update rule, an Rmsprop update rule, or a stochastic gradient descent (SGD) update rule, to the respective gradients.

FIG. 6 is a flow diagram of a further example process 600 for training a token processing neural network on a training dataset. For convenience, the process 600 will be described as being performed by a system of one or more computers located in one or more locations. For example, a training system, e.g., the training system 400 of FIG. 4, appropriately programmed in accordance with this specification, can perform the process 600.

The training dataset includes a plurality of training sequences. Each training sequence includes a prefix input sequence followed by a suffix input sequence. The prefix input sequence and the suffix input sequence can each include a respective subset of a plurality of tokens included in the training sequence.

The system generates, by the token processing neural network and in accordance with the values of the parameters of the token processing neural network, a plurality of training output sequences (step 602). Each training output sequence includes a plurality of tokens. The plurality of tokens include special tokens representing a request for an external tool and other tokens that do not represent such a request.

For each of the plurality of training output sequences, the system determines a position reward score for the training output sequence that is dependent on relative positions of the special tokens relative to the other tokens within the training output sequence (step 604).

The position reward score can be generated by using a position reward model. In some implementations, the position reward model generates a lower position reward score when the special tokens are within a threshold number of proportion of the plurality of tokens of the beginning of the training output sequence; and generates a higher position reward score when the special tokens are within a threshold number of proportion of the plurality of tokens of the end of the training output sequence. For example, a training output sequence having special tokens positioned only within the first 20% of all its tokens (relative to the beginning) will have a lower position reward score relative to another training output sequence having special tokens positioned only within the last 20% of all its tokens (relative to the beginning).

For each of the plurality of training output sequences, the system also determines a quality reward score for the training output sequence (step 606). In principle the quality can be defined with respect to any aspects of the training output sequence including, for example, a conciseness, helpfulness, relevancy, completeness, and so on. The quality reward score can be generated by using a quality reward model.

The system determines an update to values of parameters of the token processing neural network based on the plurality of training output sequences to update values of the parameters of the token processing neural network through reinforcement learning to optimize a combined objective (step 608). For each training output sequence, the combined objective can for example be computed as a weighted or unweighted combination of the position reward score and the quality reward score.

In general the system can use any reinforcement learning technique that is appropriate for the generative neural network, i.e., that uses any appropriate reinforcement learning objective function that depends on the combined objective. Examples of reinforcement learning techniques that can be used include a proximal policy optimization (PPO) algorithm (see John Schulman, et al. “Proximal policy optimization algorithms.” arXiv preprint arXiv:1707.06347 (2017)), a direct preference optimization (DPO) algorithm (see Rafael Rafailov, et al. “Direct preference optimization: Your language model is secretly a reward model.” Advances in Neural Information Processing Systems 36 (2024)), and an asynchronous actor-critic (A3C) algorithm (see Volodymyr Mnih, et al. “Asynchronous methods for deep reinforcement learning.” International conference on machine learning. PMLR, 2016).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a request from a user for an output sequence;
generating, using a token processing neural network, a first partial output sequence and an external tool request sequence, wherein the external tool request sequence comprises tokens that represent a plurality of requests for one or more external tools, and wherein the plurality of requests comprises a first request and a second request;
obtaining a first result from an external tool corresponding to the first request before obtaining a second result from an external tool corresponding to the second request;
generating, using the token processing neural network, based on the first partial output sequence and the first result, a second partial output sequence;
providing the second partial output sequence and the first partial output sequence for presentation to the user before obtaining the second result from the external tool corresponding to the second request;
obtaining the second result from the external tool corresponding to the second request;
generating, using the token processing neural network, based on the second partial output sequence and the second result, a third partial output sequence; and
providing the third partial output sequence, the second partial output sequence, and the first partial output sequence for presentation to the user.

2. The method of claim 1, wherein obtaining the first result from the external tool corresponding to the first request before obtaining the second result from the external tool corresponding to the second request comprises:
submitting the first request to the external tool corresponding to the first request as a same time as submitting the second request to the external tool corresponding to the second request; and
executing the first request to the external tool corresponding to the first request in parallel with executing the second request to the external tool corresponding to the second request.

3. The method of claim 1, wherein each request comprises an application programming interface (API) call.

4. The method of claim 1, wherein the one or more external tools comprise one or more of:
a search engine,
a machine translation system,
a question answering system,
a calculator system, or
a calendar system.

5. The method of claim 1, wherein the tokens that represent the plurality of requests for one or more external tools comprise one or more of:
tokens that identify an external tool,
tokens that define one or more arguments to pass to the identified external tool, or
tokens that define how to use a result obtained from the identified external tool.

6. The method of claim 1, wherein the plurality of requests comprises a third request for an external tool, and wherein the method further comprises:
submitting the third request to the external tool corresponding to the third request;
executing the third request to the external tool corresponding to the third request;
in response to determining that an amount of time taken by the external tool to execute the third request is greater than a threshold amount, generating, using the token processing neural network, and without using any results from the external tool corresponding to the third request, a fourth partial output sequence; and
providing the fourth partial output sequence for presentation to the user.

7. The method of claim 1, wherein the token processing neural network has been trained based on:
generating a training dataset that comprises a plurality of training sequences, each training sequence comprising a plurality of tokens; and
training the token processing neural network on training sequences obtained from the training dataset based on optimizing a language modeling objective.

8. The method of claim 7, wherein the training comprises:
obtaining a first training sequence from the training dataset, the first training sequence comprising a prefix input sequence followed by a suffix input sequence;
processing, by the token processing neural network, a training input comprising the prefix input sequence and a training external tool use sequence that includes (a) tokens representing a request for a first external tool and (b) tokens representing a result from a second external tool that is different from the first external tool to generate a training output; and
determining an update to values of parameters of the token processing neural network based on minimizing a difference between the training output and the suffix input sequence.

9. The method of claim 7, wherein the training comprises obtaining a second training sequence from the training dataset, the second training sequence comprising a prefix input sequence followed by a suffix input sequence;
processing, by the token processing neural network, a training input comprising the prefix input sequence and a training external tool use sequence that (a) includes tokens representing a request for a first external tool but (b) excludes tokens representing a result from any external tool to generate a training output; and
determining an update to values of parameters of the token processing neural network based on minimizing a difference between training output and the suffix input sequence.

10. A method performed by one or more computers for training a token processing neural network that has parameters, the method comprising:
generating, by the token processing neural network, a plurality of training output sequences, each training output sequence comprising a plurality of tokens, the plurality of tokens comprising special tokens representing a request for an external tool;
for each of the plurality of training output sequences, determining a reward score for the training output sequence that is dependent on relative positions of the special tokens within the plurality of tokens included in the training output sequence; and
training the auto-regressive token processing neural network based on the plurality of training output sequences to update values of the parameters of the auto-regressive token processing neural network through reinforcement learning to optimize the reward scores.

11. The method of claim 10, wherein for each of the plurality of training output sequences, determining the combined reward score the training output sequence comprises:
generating a lower reward score when the special tokens are within a threshold number of proportion of the plurality of tokens of a beginning of the training output sequence; and
generating a higher reward score when the special tokens are within a threshold number of proportion of the plurality of tokens of an end of the training output sequence.

12. A system comprising one or more computers and one or more storage devices storing instructions that when executed by the one or more computers cause the one more computers to perform operations comprising:
receiving a request from a user for an output sequence;
generating, using a token processing neural network, a first partial output sequence and an external tool request sequence, wherein the external tool request sequence comprises tokens that represent a plurality of requests for one or more external tools, and wherein the plurality of requests comprises a first request and a second request;
obtaining a first result from an external tool corresponding to the first request before obtaining a second result from an external tool corresponding to the second request;
generating, using the token processing neural network, based on the first partial output sequence and the first result, a second partial output sequence;
providing the second partial output sequence and the first partial output sequence for presentation to the user before obtaining the second result from the external tool corresponding to the second request;
obtaining the second result from the external tool corresponding to the second request;
generating, using the token processing neural network, based on the second partial output sequence and the second result, a third partial output sequence; and
providing the third partial output sequence, the second partial output sequence, and the first partial output sequence for presentation to the user.

13. The system of claim 12, wherein obtaining the first result from the external tool corresponding to the first request before obtaining the second result from the external tool corresponding to the second request comprises:
submitting the first request to the external tool corresponding to the first request as a same time as submitting the second request to the external tool corresponding to the second request; and
executing the first request to the external tool corresponding to the first request in parallel with executing the second request to the external tool corresponding to the second request.

14. The system of claim 12, wherein each request comprises an application programming interface (API) call.

15. The system of claim 12, wherein the one or more external tools comprise one or more of:
a search engine,
a machine translation system,
a question answering system,
a calculator system, or
a calendar system,

16. The system of claim 12, wherein the tokens that represent the plurality of requests for one or more external tools comprise one or more of:
tokens that identify an external tool,
tokens that define one or more arguments to pass to the identified external tool, or tokens that define how to use a result obtained from the identified external tool.

17. The system of claim 12, wherein the plurality of requests comprises a third request for an external tool, and wherein the method further comprises:
submitting the third request to the external tool corresponding to the third request;
executing the third request to the external tool corresponding to the third request;
in response to determining that an amount of time taken by the external tool to execute the third request is greater than a threshold amount, generating, using the token processing neural network, and without using any results from the external tool corresponding to the third request, a fourth partial output sequence; and
providing the fourth partial output sequence for presentation to the user.

18. The system of claim 12, wherein the token processing neural network has been trained based on:
generating a training dataset that comprises a plurality of training sequences, each training sequence comprising a plurality of tokens; and
training the token processing neural network on training sequences obtained from the training dataset based on optimizing a language modeling objective.

19. The system of claim 18, wherein the training comprises:
obtaining a first training sequence from the training dataset, the first training sequence comprising a prefix input sequence followed by a suffix input sequence;
processing, by the token processing neural network, a training input comprising the prefix input sequence and a training external tool use sequence that includes (a) tokens representing a request for a first external tool and (b) tokens representing a result from a second external tool that is different from the first external tool to generate a training output; and
determining an update to values of parameters of the token processing neural network based on minimizing a difference between the training output and the suffix input sequence.

20. The system of claim 18, wherein the training comprises obtaining a second training sequence from the training dataset, the second training sequence comprising a prefix input sequence followed by a suffix input sequence;
processing, by the token processing neural network, a training input comprising the prefix input sequence and a training external tool use sequence that (a) includes tokens representing a request for a first external tool but (b) excludes tokens representing a result from any external tool to generate a training output; and
determining an update to values of parameters of the token processing neural network based on minimizing a difference between training output and the suffix input sequence.

21. One or more computer storage media storing instructions that when executed by one or more computers cause the one more computers to perform operations comprising:
receiving a request from a user for an output sequence;
generating, using a token processing neural network, a first partial output sequence and an external tool request sequence, wherein the external tool request sequence comprises tokens that represent a plurality of requests for one or more external tools, and wherein the plurality of requests comprises a first request and a second request;
obtaining a first result from an external tool corresponding to the first request before obtaining a second result from an external tool corresponding to the second request;
generating, using the token processing neural network, based on the first partial output sequence and the first result, a second partial output sequence;
providing the second partial output sequence and the first partial output sequence for presentation to the user before obtaining the second result from the external tool corresponding to the second request;
obtaining the second result from the external tool corresponding to the second request;
generating, using the token processing neural network, based on the second partial output sequence and the second result, a third partial output sequence; and
providing the third partial output sequence, the second partial output sequence, and the first partial output sequence for presentation to the user.
